(19) United States
(12) Patent Application Publication
(10) Pub. No.: US 2006/0037447 A1
(43) Pub. Date: Feb. 23, 2006

(54) Multi-blade adaptor

(76) Inventors: Frederick Scott Groven, Garden Valley, CA (US); James Stanley Morris, Torrance, CA (US)

Correspondence Address: F. Scott Groven, 5801 Mt. Murphy Rd., Garden Valley, CA, 95633, US

(21) Appl. No.: 10/922,044

(22) Filed: Aug. 18, 2004

(51) Int. Cl. B26D 1/00

(52) U.S. Cl. 83/13

(57) ABSTRACT

A multi-blade adaptor is comprised of a drive bushing that is inserted into a circular saw and of a cap or blade clamp that fits onto the drive bushing, sandwiching the blades between the two.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

1. Field of Invention

This invention generally relates to a circular saws, specifically to an improved saw blade holder.

2. Prior Art

Existing circular saws have the ability but are limited to the use of one blade at a time. While excellent for normal use, when used for repetitive, dado or notch type cuts in wood or other materials, it can be limited and is a slow and potentially dangerous operation.

### OBJECTS AND ADVANTAGES

Accordingly, several objects and advantages of my invention are: the ability to insert up to three saw blades at a time on a saw. The addition of more blades allows the user to reduce time by making a single cut that is three times the width of previous capabilities in the same amount of time. My invention can be used with wood cutting blades, masonry blades, steel cutting blades and diamond blades, etc. Also, from a safety standpoint, by decreasing the number of cuts there are fewer chances for the saw to kick or bind leading to injury. My invention allows the user to change from a single blade configuration to a triple blade configuration as simply as changing a typical blade.

### SUMMARY

In accordance with the present, a multi-blade adaptor is comprised of a drive bushing that is inserted into a circular saw and of a cap or blade clamp that fits into the drive bushing sandwiching the blades between the drive bushing and the cap.

### DRAWINGS—FIGURES

FIG. 1 is a side and front view of the drive bushing, also shown in FIG. 3, Detail 2

FIG. 2 is a side and front view of the cap or blade clamp portion of my invention as shown in FIG. 3, Detail 1

FIG. 3 is a side and front view of my invention components separately, FIG. 1, Detail 1 and 2. Details 3, 4 and 5 show assembly of both parts from a side view.

### DRAWINGS—REFERENCE NUMERALS

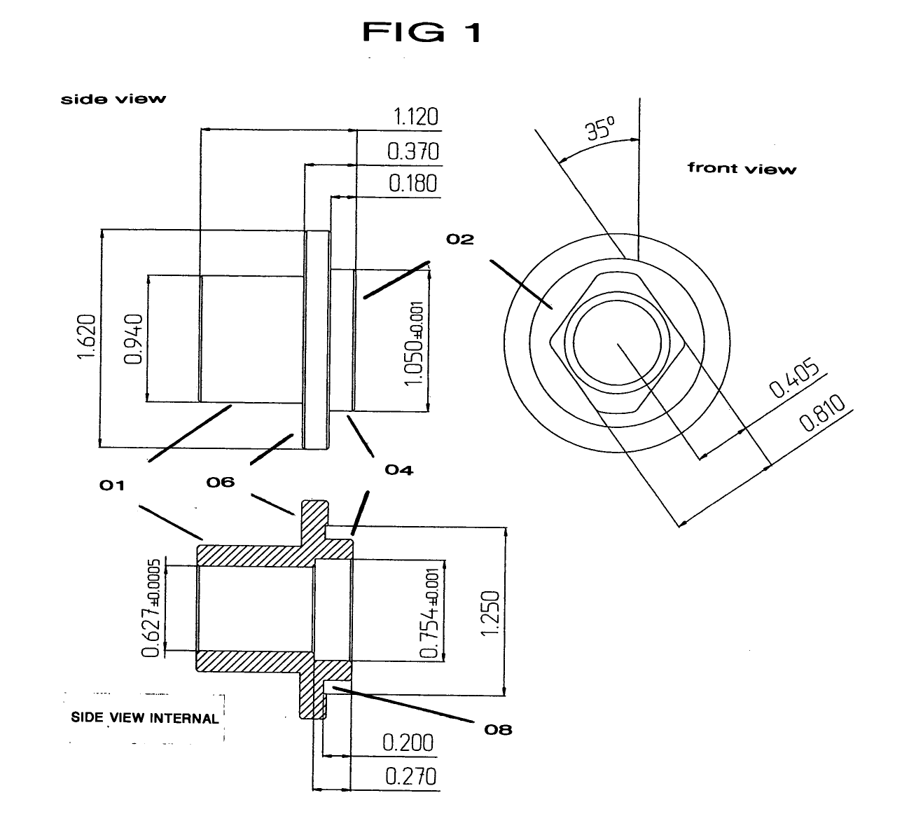

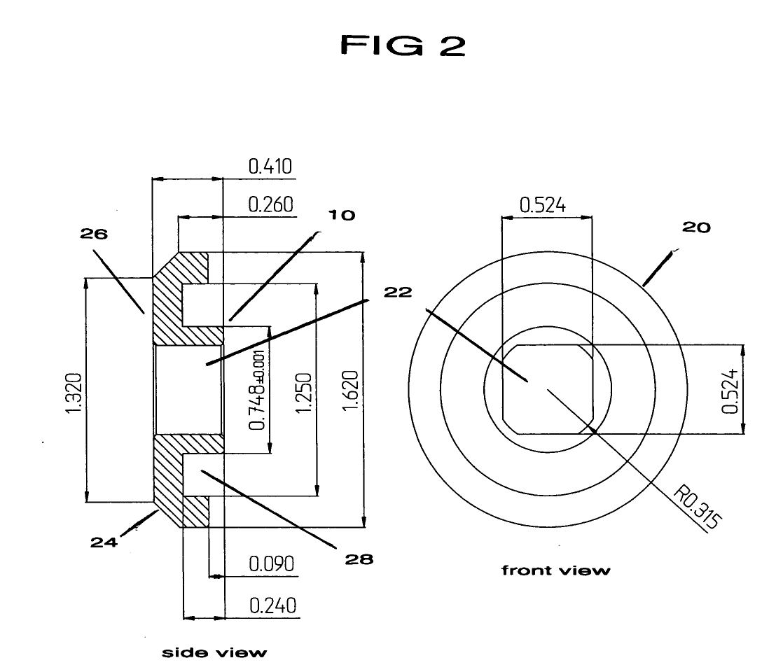

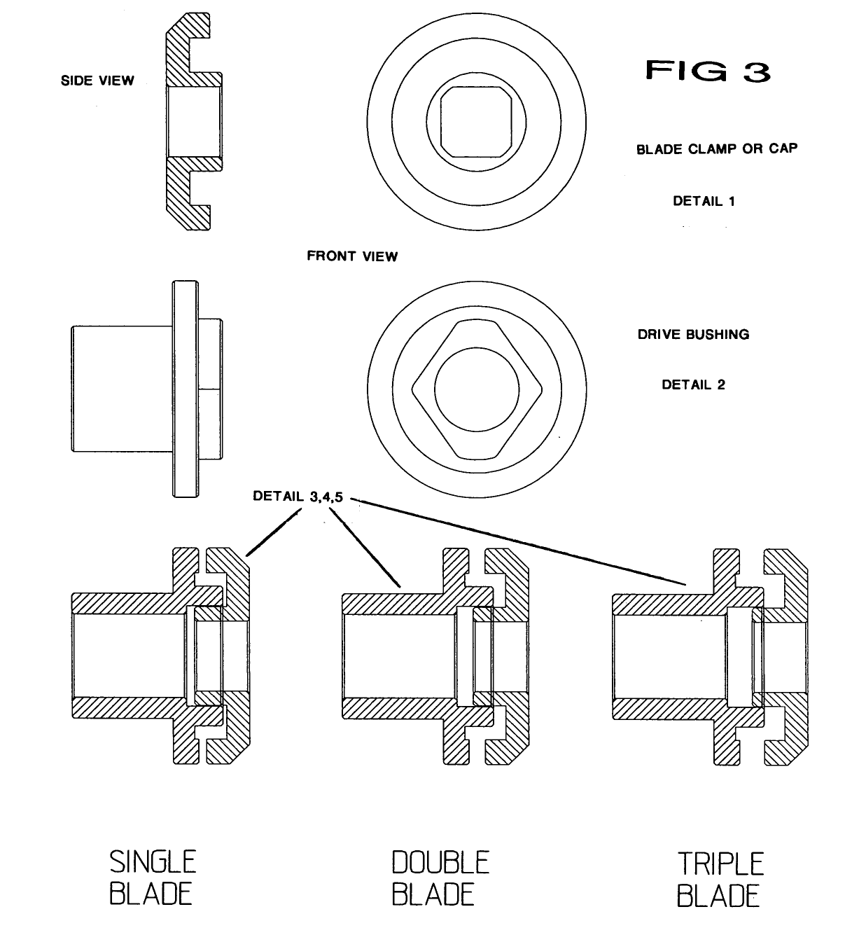

FIG. 1 Drive bushing
   Detail 01: Rounded sleeve
   Detail 02: Diamond shaped raised area
   Detail 04: Height of diamond shaped area
   Detail 06: Flat surface
   Detail 08: Raised outer circle
FIG. 2 Blade clamp or blade cap
   Detail 10: Extended center section
   Detail 20: Circular cap
   Detail 22: Centered hole
   Detail 24: Beveled edge
   Detail 26: Top of piece
   Detail 28: Channel in back
FIG. 3 Drive bushing, blade clamp or blade cap, assembled parts
   Detail 1: Blade clamp
   Detail 2: Drive bushing
   Detail 3: Single blade
   Detail 4: Double blade
   Detail 5: Triple blade

### DETAILED DESCRIPTION—PREFERRED EMBODIMENT

All measurements are show in inches.

FIG. 1 shows front and side view of the drive bushing part of the invention. The bushing is a rounded sleeve (Detail 01) that is designed to fit the drive shaft of a circular saw engine. The bushing has a diamond shaped raised area of a width of 0.810 (Detail 02) and a height of 0.180 (Detail 04) protruding from a flat surface area of 1.620 on the back side (Detail 06). Towards the front, there is a raised outer circle at 0.10 (Detail 08). The entire part is to be made of 1144 stress proof heat treated to 48-50 Rc. or similar acceptable materials.

FIG. 2 shows both the front and side view of the blade clamp or cap part of my invention. The cap is a circular piece 1.620 wide and 0.410 thick (Detail 20). There is a hole centered with a width of 0.524 (Detail 22). The outside edge is beveled off at 0.26 from the bottom (Detail 24). The top of the piece is 1.320 (Detail 26) and the back is a channel 0.26 (Detail 28) deep from the center, 0.748-1.250 wide. The outside width is 0.090 narrower than the center piece. The piece is to be made of 1144 stress proof heated treated to 48-50 Rc or similar acceptable material.

FIG. 3 show both side and front views of the cap portion (FIG. 2) and the drive bushing portion (FIG. 1). It also shows side views of bushing and cap together (Details 3, 4, 5 of FIG. 3).

### OPERATION AND ALTERNATIVE EMBODIMENTS

The operation of the multi-blade adaptor is as the drive bushing (FIG. 1) is installed onto a circular saw. Circular saw blades are added, from one to three, over the raised diamond shaped portion (FIG. 1, Detail 02). The blade clamp or cap (FIG. 2) is placed over drive bushings extended center section (FIG. 2, Detail 10) that slides through the saw blades and is inserted into the drive bushing (FIG. 1). The existing bolt on the saw is used to sandwich the parts together.

### CONCLUSION, RAMIFICATIONS, AND SCOPE

The multi-blade adaptor provides the user with a safe and time-saving way of making a variety of cuts in natural woods or other materials where a wider cut would be necessary. While my above description contains some specificities, those should not be construed as limitations on the scope of the invention, but rather as an exemplification of one preferred embodiment thereof. Many other variations are possible. For example, with the use of different types of blades, i.e., masonry, steel or diamond blades, you can use the invention with alternative blades allowing you to make notches in concrete or tile, or for notching metal studs in commercial construction.

1. Means for adding additional saw blades on to a circular saw, with a limit of three blades, to reduce the number of cuts and/or passes necessary to make dado or notch-type cuts in wood, steel, concrete, ceramic tile, or other materials.

2. The above-mentioned part may be comprised 1144 stress proof, heat treated to 48-50 Rc.

3. The above-mentioned part may be comprised of any other materials with properties which are of equal or better values of the 1144 stress proof, heat treated to 48-50 Rc.
